(19) United States
(12) Patent Application Publication
(10) Pub. No.: US 2007/0003685 A1
(43) Pub. Date: Jan. 4, 2007

(54) Prostacyclin production-increasing agent and blood flow enhancer

(75) Inventor: Yuko Watanabe, Noda-shi (JP)

Correspondence Address: BIRCH STEWART KOLASCH & BIRCH, PO BOX 747, FALLS CHURCH, VA, 22040-0747, US

(73) Assignee: Kikkoman Corporation

(21) Appl. No.: 11/476,665

(22) Filed: Jun. 29, 2006

(30) Foreign Application Priority Data
Jul. 1, 2005 (JP) 2005-193747

(51) Int. Cl. A23L 2/00

(52) U.S. Cl. 426/599

(57) ABSTRACT

The present invention is to provide a novel prostacyclin production-increasing agent, a blood flow enhancer, a prophylaxis or improvement agent of blood flow disorder, or a skin improving agent, each of which comprises an elderberry extract as an effective ingredient, and foods, medicaments or cosmetics containing the same.

### BACKGROUND ART

1. Field of the Invention

The present invention relates to a prostacyclin production-increasing agent comprising an elderberry extract as an effective ingredient, a blood flow enhancer, a prophylaxis or improvement agent of blood flow disorder, or a skin improving agent. Also, the present invention relates to drinks and foods, medicaments or cosmetics containing the above composition.

2. Prior Art

Elderberry (Sambucus nigra L.) is a plant belonging to caprifoliaceae and originating from Europe, and also known as another name of European elder. It has been well known that respective tissues of elderberry have a medical use or a health promoting action. For example, it has an anti-inflammatory action or anti-viral action in addition to perspiration and diuretic action (Non-Patent Literature 1).

Blood flow disorder causes diseases or symptoms such as necrosis of a tissue, high blood pressure, stiffness of shoulders, poor circulation, darkish of skin, dark circles under eyes, etc. Also, in skin containing dye deposition accompanied by aging or dried skin, circulation of blood in a capillary is poor so that nutrient does not reach to cells sufficiently whereby waste cannot smoothly be removed.

It is possible to carry out prophylaxis or improvement of various kinds of diseases or symptoms caused by blood flow disorder by improving blood flow in a body. Also, by the improvement in blood flow, the conditions of skins can be improved and a healthy state can be maintained.

Prostacyclin (PGI₂) has a platelet aggregation inhibiting action and vasodilating action by relaxing smooth muscle of a blood vessel. Also, prostacyclin derivatives inhibit lowering in a blood flow amount at the skin, so that it is effective for therapy or treatment of peripheral blood flow disorder (Non-Patent Literature 2).

To improve blood flow in a body, it is useful to increase prostacyclin production in endothelial cells of a blood vessel, or to increase a number of prostacyclin production cells. As a prostacyclin production-increasing agent, an extract of botan bofu (Peucedanum japonicum) has been known (Patent Literature 1).

It has also been known that various kinds of vegetable extracts have a blood flow improvement action. A composition containing cassis concentrate (effective ingredient: anthocyanin) and at least one selected from the group consisting of an amino acid and an organic acid relaxes symptoms such as stiffness of shoulders or poor circulation, etc. which are blood flow disorder by a peripheral blood flow improvement and vasodilating action (see Patent Literature 2). Citral extracted from vegetables such as lemon grass (Cymbopogon citratus), etc. has also blood flow improvement effect (Patent Literature 3).
[Patent Literature 1] Japanese Laid-Open Patent Publication No. 2005-350432
[Patent Literature 2] Japanese Laid-Open Patent Publication No. 2004-262878
[Patent Literature 3] Japanese Laid-Open Patent Publication No. 2000-044467
[Non-Patent Literature 1] Alter Med. Rev.: Vol. 10 (No. 1) pp. 51-55 (2005)
[Non-Patent Literature 2] Jpn. J. Pharmacol.: Vol. 59 (No. 1) pp. 57-63 (1992.05)

### SUMMARY OF THE INVENTION

An object of the present invention is to provide a novel prostacyclin production-increasing agent, a blood flow enhancer, a prophylaxis or improvement agent of blood flow disorder, a skin improving agent, or foods, medicaments or cosmetics containing the agent.

The present inventor has found that elderberry extract has a prostacyclin production-increasing activity and blood flow improving activity to accomplish the present invention. That is, the present invention relates to the following.
1. A prostacyclin production-increasing agent comprising an elderberry extract as an effective ingredient.
2. A blood flow enhancer comprising an elderberry extract as an effective ingredient.
3. A prophylaxis or improvement agent of blood flow disorder comprising an elderberry extract as an effective ingredient
4. A skin improving agent comprising an elderberry extract as an effective ingredient.
5. Foods, medicaments or cosmetics containing the agent according to any one of the above 1 to 4.
6. A method of increasing prostacyclin production of human which comprises orally administering an effective amount of an elderberry extract to an adult person.
7. A method of enhancing blood flow of human which comprises orally administering an effective amount of an elderberry extract to an adult person.
8. A method of prophylaxis or treatment of blood flow disorder which comprises orally administering an effective amount of an elderberry extract to a patient suffered from blood flow disorder.
9. A method of improving skin state of human which comprises orally administering an effective amount of an elderberry extract to an adult person.
10. The method according to any one of the above 6 to 9, wherein the elderberry extract is administered in an amount of 10 mg to 5 g per day for the adult person.
   [Effects of the Invention]

In the present invention, by using an elderberry extract which is a component derived from natural product as an effective ingredient, an excellent prostacyclin production-increasing action, and blood flow promoting action are observed. According to the present invention, a prostacyclin production-increasing agent, a blood flow enhancer, a prophylaxis or improvement agent of blood flow disorder, or a skin improving agent each of which comprises an elderberry extract as an effective ingredient can be provided. Also, according to the present invention, foods, medicaments or cosmetics containing the above-mentioned agent can be provided.

### BRIEF DESCRIPTION OF THE DRAWINGS

FIG. 1 is a graph showing prostacyclin production-increasing activities of various kinds of berry extracts.

FIG. 2 is a graph showing prostacyclin production-increasing activities of the elderberry extract at various kinds of concentrations.

FIG. 3 is a graph showing prostacyclin production-increasing activities of fractions of the elderberry extract.

FIG. 4 is a drawing showing change in blood flow amounts of the control group and the elderberry treated group.

### PREFERRED EMBODIMENTS OF THE INVENTION

The “elderberry extract” to be used in the present invention may be a material obtained by extracting an elderberry according to any of extraction methods, so long as it has a prostacyclin production-increasing activity, a blood flow promoting activity or a skin improving activity. The elderberry extract means, for example, a fruit juice obtained by compressing elderberry fruit, or an extract obtained by extracting whole fruit of elderberry or a suitable portion of skin, seed, etc. of the fruit according to the conventionally known optional extracting method for those skilled in the art, and the like. Also, a crushed product of an elderberry fruit, or an elderberry fruit is boiled down to a jam state can be used as “an elderberry extract” of the present invention.

A plant body of the elderberry which is a starting material to be used for extraction may be either of a dried or crushed material of the fruit portion, etc., or a raw or frozen material. Further, a residue after collecting a fruit juice by compressing an elderberry fruit generating during preparation of drinks, i.e., a compressed residue may be used as a starting material for extraction.

Preferred example of extraction may include that it is carried out by using water or an organic solvent, etc., under suitable conditions. At the time of the extraction, it is preferably carried out optionally under heating. The organic solvent may be mentioned, for example, a water-soluble alcohol such as methanol, ethanol, isopropanol, n-butanol, etc., acetone, acetic acid, etc. The water-soluble organic solvent may be used alone, but may be used in combination with water with an optional ratio. Ethanol is preferred as the water-soluble organic solvent since it is low toxicity, easy in removal thereof after extraction due to its low boiling point, and easily available, an the like. For the purpose of heightening extraction efficiency, and lowering a ratio of impurities, a mixing ratio of ethanol:water is preferably 1:4 to 4:1 (v/v).

An amount of the solvent at the time of extraction based on the amount of the elderberry starting material is not specifically limited, and usually 1 to 100-fold amount (v/w), preferably 2 to 10-fold amount. And if necessary, a small amount of a surfactant (for example, sucrose fatty acid ester, etc.) or an antioxidant (for example, ascorbic acid, etc.) may be added. Also, if necessary, extraction may be carried out under inert gas atmosphere.

At the time of extraction of the elderberry, the extraction is preferably carried out at room temperature to 100° C. or so under heating. An extraction time may vary depending on the extraction conditions such as an amount of a solvent, a kind of the solvent, a temperature, etc., and generally about 10 minutes to 24 hours, preferably about 30 minutes to 4 hours.

The crude extract obtained by extracting the elderberry with an organic solvent, etc., may be used by carrying out concentration and/or drying, if desired.

The thus prepared crude extract can be used as the elderberry extract which is an effective ingredient of the present invention. Further, an elderberry extract containing an effective ingredient with high purity can be obtained by subjecting the crude extract to purification, separation and/or decoloration treatment such as column chromatograph using Sephadex, polyamide, silica gel, ODS, etc., membrane separation using a cellulose membrane, etc., liquid-liquid separation using ethyl acetate-water, etc., decomposition of impurities by addition of microorganisms such as yeast, etc. As shown in the following Examples, an extract obtained by extracting an elderberry fruit with 50% ethanol is applied to ODS column, and then, eluted with an eluent containing ethanol with a concentration of 80 to 100%, an elderberry extract showing potent prostacyclin production-increasing activity can be obtained. Also, as the elderberry extract of the present invention, a commercially available product may be used.

As shown in Examples, the elderberry extract shows a prostacyclin production-increasing action in a system of a normal human umbilical vein endothelial cells (HUVEC), and shows a blood flow promoting action at the lower limb portion of a rat. By utilizing the above-mentioned actions possessed by the elderberry extract, the elderberry extract can be used as a prophylaxis or improvement agent of blood flow disorder. Here, improvement of skin means improvement of various symptoms of skin (for example, darkish of skin, dark circles under eyes) caused by increase in prostacyclin production or blood flow promotion.

The elderberry extract of the present invention can be used by adding to foods, medicaments or cosmetics. There is no specific limitation on the kind, form and other components contained in foods, medicaments or cosmetics, and these materials can be easily prepared according to the optional and various methods already known for those skilled in the art.

A content of the elderberry extract contained as an effective ingredient in foods, medicaments or cosmetics is not particularly limited so long as it shows an action of the present invention, i.e., increase in prostacyclin production, blood flow promotion, prophylaxis or improvement of blood flow disorder, prophylaxis or improvement of diseases caused by blood flow disorder, or improvement of skin, and can be optionally determined.

Incidentally, in the respective agents of the present invention, various kinds of other components conventionally known for those skilled in the art may be contained so long as it does not exert any bad effects on the action of the effective ingredient.

[Foods of the Present Invention]

As a form of foods of the present invention, there may be formulated to any optional forms, for example, a granule state, a grain state, a paste state, a gel state, a solid state, or a liquid state. In these forms, various kinds of substances conventionally known for those skilled in the art which have been allowed to add to foods, for example, a binder, a disintegrant, a thickener, a dispersant, a reabsorption promoting agent, a tasting agent, a buffer, a surfactant, a dissolution aid, a preservative, an emulsifier, an isotonicity agent, a stabilizer or a pH controller, etc. may be optionally contained. An amount of the elderberry extract to be added to foods is not specifically limited, and for example, it may be about 10 mg to 5 g, preferably 50 mg to 2 g per day as an amount of take-in by an adult weighing about 60 kg.

In particular, when it is utilized as foods for preservation of health, functional foods, etc., it is preferred to contain the effective ingredient of the present invention in such an amount that the predetermined effects of the present invention are shown sufficiently.

[Medicaments of the Present Invention]

The medicaments of the present invention can be optionally prepared according to the conventionally known methods, for example, as a solid agent such as a tablet, a granule, powder, a capsule, etc., or as a liquid agent such as an injection, etc. To these medicaments, there may be formulated any materials generally used, for example, such as a binder, a disintegrant, a thickener, a dispersant, a reabsorption promoting agent, a tasting agent, a buffer, a surfactant, a dissolution aid, a preservative, an emulsifier, an isotonicity agent, a stabilizer or a pH controller.

The medicaments of the present invention can be optionally used orally or non-orally. That is, desired action is shown by oral, intravenous, or abdominal administration, etc.

An administration amount of the effective ingredient (elderberry extract) in the medicaments may vary depending on a kind, an agent form, an age, a body weight or a symptom to be applied of a patient, and the like, for example, when it is administrated orally, it is administered one or several times per day for an adult weighing about 60 kg, and administered in an amount of about 10 mg to 5 g, preferably about 50 mg to 2 g per day.

[Cosmetics of the Present Invention]

The cosmetics of the present invention can be also made in an optional form, for example, a liquid state, a paste state, or, a gel state. In these substances, various kinds of substances conventionally known for those skilled in the art which have been allowed to add to cosmetics may be optionally contained. An amount of the elderberry extract based on an amount of the cosmetics is not particularly limited, and for example, it may be about 10 mg to 5 g, preferably about 50 mg to 2 g per day for an adult and as an amount which can be used as the cosmetics.

In the following, the present invention is explained in more detail by referring to Examples, but the technical range of the present invention is not at all limited by these descriptions.

### EXAMPLE 1

Preparation of Elderberry Extract:

Elderberry fruit made in Europe was freeze-dried, and pulverize to obtain fruit powder. 10 g of this fruit powder was extracted with 100 ml of 50% ethanol for 3 hours at 50° C., the extract was concentrated, and freeze-dried to obtain an elderberry extract. Total polyphenol amount contained in the extract was 5.8%.

### EXAMPLE 2

Measurement Test of Amount of Prostacyclin:

By using various kinds of berry extracts as samples, prostacyclin production-increasing activities thereof were measured.

2.1 Samples

Elderberry extract (described in Example 1)
Cranberry extract (“cranberry extract” available from Kikkoman)
Mulberry extract (50% ethanol extract of “mulberry seed extract” available from AIT-ONE Co., Ltd.)
Aronia extract (“ANTHOCYANINS POWDER from ARONIA MELANOCARPA” available from AGROPHRM S.A. Inc.)
Black currant extract (50% ethanol extract of “frozen fruit (made in Canada)” available from Pacific Coast Fruit Products Ltd.)
Acai berry extract (50% ethanol extract of “Acai pulp powder”, available from VDF Co.)
Honey berry extract (50% ethanol extract of “fruit freeze-dry product” available from Karinto-ya, Hokkaido, Japan)
Raspberry extract (50% ethanol extract of “20% raspberry powder”, available from VDF Co.)
   2.2 Measurement Method of Prostacyclin Production-Increasing Activity

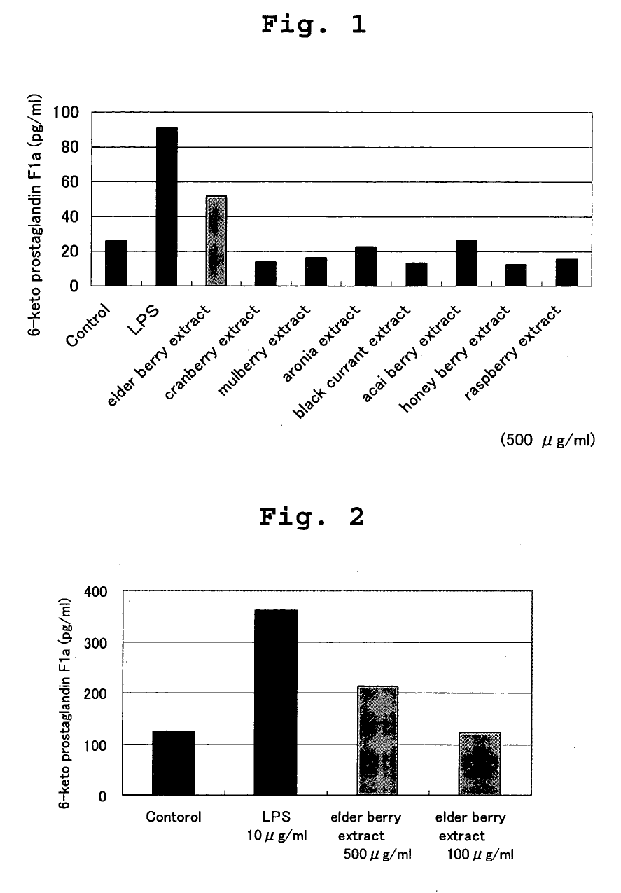

Normal Human umbilical vein endothelial cells (HUVEC) (available from TaKaRa Bio Inc.) were sewed to 24-hole plate (FALCON) in an amount of each 500 μl (0.5×10⁵ cells/ml), and cultured in a minute blood vessel endothelial cells medium (EGM™-2) (5% FBS) until it becomes confluent under the conditions of at 37° C. and 5% CO₂. Thereafter, they were exchanged to a medium to which various kinds of concentrations of a sample were added, and cultured for further 18 hours. The culture plate was centrifuged at 1,200 rpm for 10 minutes, to recover culture cell supernatant. A prostacyclin concentration in the supernatant was measured as a concentration of 6-keto Prostaglandin F_{1α} (pg/ml) which is a stable metabolite of the prostacyclin. In FIG. 1, when the concentration of the metabolite is high, it means that prostacyclin production in the endothelial cells of the blood vessel is increased, or a prostacyclin production-increasing activity of the sample is high.

Incidentally, measurement of the 6-keto prostaglandin F_{1α} a was carried out by using 6-keto Prostaglandin F_{1α} EIA Kit (available from Cayman Inc.).

2.3 Measurement Results

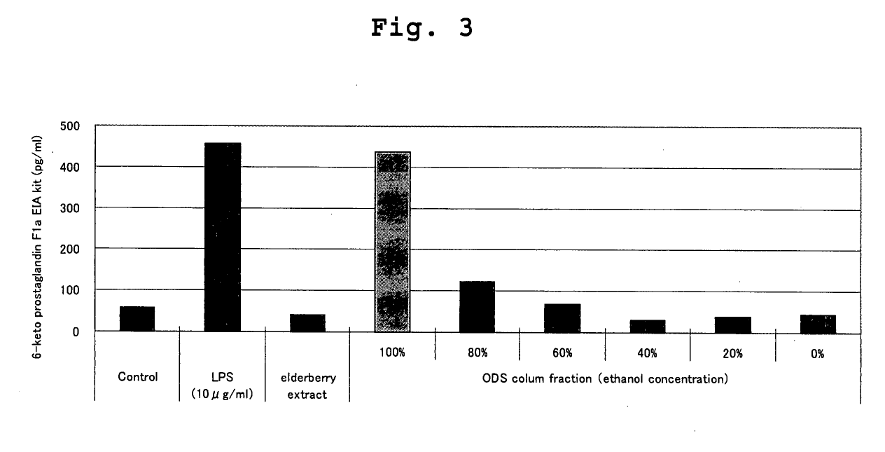

(1) Among the various kinds of berry-derived samples, elderberry extract alone showed prostacyclin production-increasing activity (FIG. 1). The vertical axis of FIG. 1 shows an amount of 6-keto Prostaglandin F_{1α}. LPS means lipopolysaccharide used as a positive control. Also, the concentration in FIG. 1 means the final concentration of each sample added to the medium in Example 2.
(2) Elderberry extract showed a concentration-dependent prostacyclin production-increasing action (FIG. 2). The concentration in FIG. 2 means final concentrations of lipopolysaccharide and the elderberry extract added to the medium in Example 2.

(3) The elderberry extract prepared in Example 1 was applied to an ODS column, and eluted with an ethanol concentration of 20, 40, 60, 80 and 100% to obtain fractions. In the method of Example 2, they were added to the medium so that the final concentrations of the respective fractions became 500 μg/ml to measure the prostacyclin production-increasing activity. As a result, a fraction eluted by 80% ethanol and a fraction eluted by 100% ethanol showed strong activities (FIG. 3). Incidentally, it could be confirmed that no polyphenol is contained in the fractions eluted by 80% and 100% ethanol (Table 1).

TABLE 1

| | ODS column | | | | | | |
|---|---|---|---|---|---|---|---|
| | ethanol concentration | | | | | | |
| | (%) | | | | | | |
| | 100 | 80 | 60 | 40 | 20 | 0 | Total |
| Total polyphenol | 0.0 | 0.0 | 0.1 | 1.2 | 3.2 | 1.3 | 5.8 |
| concentration | | | | | | | |
| (%) | | | | | | | |

According to this test, it is clear that the elderberry extract has a prostacyclin production-increasing action. Thus, it has been shown that the elderberry extract can be utilized for improvement in blood flow, prophylaxis or improvement of blood flow disorder, or improvement in skin based on the prostacyclin production-increasing action.

### EXAMPLE 3

Test of Improvement in Blood Flow:

According to the experiment shown below, a blood flow improving activity of the elderberry extract was confirmed.

3.1 Measurement Method of Blood Flow

HOS: HR-1 hair-less mouse, 6-weeks old (male) was freely fed for 7 days with feed (MF powder) in which an elderberry extract (described in Example 1) had been mixed in a ratio of 4%, and a blood flow amount at back skin before and after take-in was measured by a laser blood flow imaging device (manufactured by Integral Inc.). The test was carried out with n=8 (eight mice) per each control group (MF powder treated group) and elderberry treated group. Incidentally, the laser blood flow imaging device is a device in which a blood flow amount is analyzed by measuring change in a current due to Doppler effect (change in frequency of light) occurred at the time when the laser light hits moving particles such as erythrocytes, etc.

3.2 Measurement Results

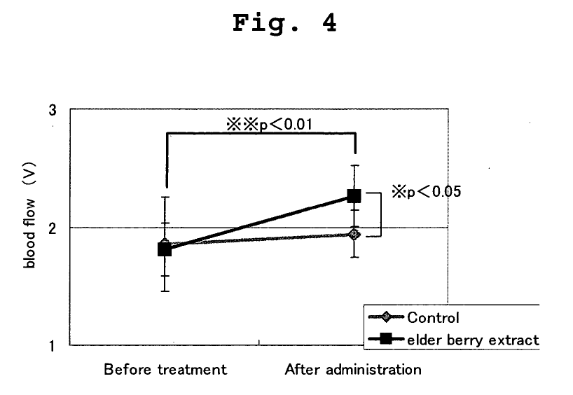

Measurement results of the blood flow amount are shown in FIG. 4. In the figure, the larger numeral value of the vertical line (V) means the larger blood flow amount.

In the elderberry group, the blood flow amount after take-in significantly increased (p<0.01) as compared to the value before take-in. Also, when the blood flow amounts after take-in of the elderberry group and the control group are compared to each other, the blood flow amount of the elderberry group is significantly large (p<0.05) than that of the control group.

According to this experiment, it is clear that the elderberry extract has a blood flow promoting action, particularly has a blood flow promoting action in peripheral blood vessel. Therefore, it has been shown that the elderberry extract can be utilized for prophylaxis and improvement of blood flow disorder, for prophylaxis and improvement of diseases caused by blood flow disorder, or for improvement of skin, based on the blood flow improving effect.

### EXAMPLE 4

The dry powder state elderberry extract used in Example 1 can be made foods, medicaments or cosmetics by the method as mentioned below.

<Tablet Type Internal Medicine or Functional Foods>

50 mg of an elderberry extract, 80 mg of lactose, 60 mg of crystalline cellulose and 10 mg of sucrose fatty acid ester were tableted as a tablet according to the conventional manner. This tablet can be used as oral medicaments or functional foods.

<Emulsion Type Internal Medicine or Functional Foods>

100 mg of an elderberry extract, 70 mg of medium chain saturated fatty acid triglyceride, 1 mg of vitamin E, 20 mg of orange oil, 30 mg of decaglycerin monostearate, 750 mg of glycerin, 10 g of glucose, 1 g of citric acid, and 500 mg of ascorbic acid were added to water to make up total amount 100 ml, and the mixture was subjected to disperse-emulsification treatment according to the conventional manner to prepare an emulsified liquid agent. This liquid agent can be used as internal medicaments or functional foods.

<Powder and Granule Type Internal Medicine or Functional Foods>

0.1 g of elderberry extract, 1.1 g of corn starch, and 0.8 g of lactose were mixed to prepare powder or granule to be used for one time according to the conventional manner. This powder or granule can be used as internal medicaments or functional foods.

<Injection>

A mixed solution containing 2% by weight of elderberry extract, 8% by weight of a surfactant, and 90% by weight physiological saline was sterilized by heating to prepare an injection.

<Candy Type Functional Food>

5 g of elderberry extract, 43 g of sugar, 42 g of starch syrup, 5 g of water, 2 g of fruit juice, 2 g of a thickener, 1 g of ascorbic acid, 0.1 g of a spice, and 0.1 g of vitamin E were mixed to prepare a candy each has a weight of5 g according to the conventional manner.

<Drink Type Functional Food>

15 g of the elderberry extract, and 985 g of an elderberry juice (100% fruit juice) were mixed by a mixer to prepare a uniform drink.

[Utilizability in Industry]

The elderberry extract contained in various kinds of agents of the present invention as an effective ingredient shows a prostacyclin production-increasing action and a blood flow promoting action. Accordingly, by using the same, excellent effects can be expected in improvement of blood flow, prophylaxis or improvement of blood flow disorder, or improvement of skin. Also, various kinds of agents containing the effective ingredient, and foods, medicaments or cosmetics containing the same can be economically provided.

What we claimed is:

1. A prostacyclin production-increasing agent which comprises an elderberry extract as an effective ingredient.

2. Foods, medicaments or cosmetics containing the agent according to claim 1.

3. A blood flow enhancer which comprises an elderberry extract as an effective ingredient.

4. Foods, medicaments or cosmetics containing the agent according to claim 3.

5. A prophylaxis or improvement agent of blood flow disorder which comprises an elderberry extract as an effective ingredient.

6. Foods, medicaments or cosmetics containing the agent according to claim 5.

7. A skin improving agent which comprises an elderberry extract as an effective ingredient.

8. Foods, medicaments or cosmetics containing the agent according to claim 7.

9. A method of increasing prostacyclin production of human which comprises orally administering an effective amount of an elderberry extract to an adult person.

10. The method according to claim 9, wherein the elderberry extract is administered to the adult person in an amount of 10 mg to 5 g per day for the adult person.

11. A method of enhancing blood flow of human which comprises orally administering an effective amount of an elderberry extract to an adult person.

12. The method according to claim 11, wherein the elderberry extract is administered in an amount of 10 mg to 5 g per day for an adult person.

13. A method of prophylaxis or treatment of blood flow disorder which comprises orally administering an effective amount of an elderberry extract to a patient suffered from blood flow disorder.

14. The method according to claim 13, wherein the elderberry extract is administered in an amount of 10 mg to 5 g per day for an adult patient.

15. A method of improving skin state of human which comprises orally administering an effective amount of an elderberry extract to an adult person.

16. The method according to claim 15, wherein the elderberry extract is administered in an amount of 10 mg to 5 g per day for the adult person.
